(19) United States
(12) Patent Application Publication
(10) Pub. No.: US 2009/0138343 A1
(43) Pub. Date: May 28, 2009

(54) Voting System

(76) Inventors: Anthony M. Knowles, Hampshire (GB); Andrew D. Blore, Surrey (GB)

Correspondence Address: DICKSTEIN SHAPIRO LLP, 1825 EYE STREET NW, Washington, DC, 20006-5403, US

(21) Appl. No.: 11/920,755

(22) PCT Filed: May 26, 2006
(86) PCT No.: PCT/GB2006/001937

§ 371 Date: Feb. 13, 2008

(30) Foreign Application Priority Data
May 26, 2005 (GB) 0510804.8

(51) Int. Cl. G07C 13/00

(52) U.S. Cl. 705/12

(57) ABSTRACT

An apparatus is disclosed for conducting a ballot in which at least one vote is cast by a voting input device (8), the apparatus comprising means (2) for receiving voting preference data for the or each vote; wireless communication means (22) for receiving a voting input from the voting input device, the voting input confirming that the voting preference data is to be used; and means (4) for recording votes in the ballot, adapted to record the or each vote in accordance with the voting preference data in response to receiving the voting input. A voting input device, voting system, voting receipt, and associated methods are also disclosed. The invention finds particular application in the field of large scale ballots, such as votes conducted at Annual General Meetings (AGMs).

The present invention relates to an apparatus, voting input device, voting system, voting receipt, carrier medium, and a method of conducting a ballot in which at least one vote is cast by a voting input device.

In large scale ballots, such as votes on motions proposed at Annual General Meetings (AGMs) of publicly listed companies, voters participating in the ballot may be entitled to more than one vote each. For example, shareholders in a company may have voting rights proportional to the number of shares owned, such that an owner of 10 shares may be allocated 10 votes, and an owner of 1,000 shares may be allocated 1,000 votes, and so on.

Voting rules at AGMs may also permit proxy voting, for example, whereby a shareholder can appoint a representative to vote on his behalf. Sometimes a single representative may be appointed to act as proxy for more than one shareholder, and may be given different voting instructions by the different shareholders. Sometimes even a single shareholder may choose to divide his vote on a particular motion. In these cases, the voter will cast a certain number of votes (which may be zero) ‘for’ a particular motion, a certain number of votes ‘against’ the motion, and a certain number abstaining from the vote. This type of vote is often referred to as a ‘split vote’.

In AGMs and the like, paper-based poll cards are used to cast split votes. On these poll cards, voters record separately the number of votes ‘for’ and ‘against’ (and optionally ‘abstaining’ from) each of a set of motions (resolutions), by filling in appropriate spaces in the poll card, and the votes are cast by placing the poll card into appropriate ballot boxes. After the final voting period ends, the votes inside the ballot boxes are counted, and the results for each motion are determined.

This method of conducting such large scale ballots is time-consuming, since each poll card must be manually counted, and the cards may contain complicated handwritten directions which are difficult to interpret.

Electronic voting systems exist which can speed up the aspects of the voting process. EP 1 535 487, the content of which is hereby incorporated by reference, discloses one such system in which a user presses a key on the keypad of a wireless voting handset to indicate a selection from a number of available voting choices. This system can be extended to the case where each voter can cast at least one vote, and in particular to the casting of a split vote. The numeric keypad could be used, for example, to enter the numbers of votes to allocate to each of the voting choices (such as ‘FOR’, ‘AGAINST’, ‘ABSTAIN’), but this would require data entry to be carried out using a moderately complex user interface and within a relatively short period of time.

A compromise between paper-based and electronic voting is sometimes reached in AGMs, for example, whereby shareholders use electronic voting if they wish to cast all of their votes for one voting choice, but use paper-based poll cards if they wish to cast more complicated (split) votes. In this case, a provisional voting result may be determined relatively quickly, but a final result can only be determined by a manual count of the poll cards which, as noted previously, introduces a considerable delay.

A first aspect of the invention provides an apparatus for conducting a ballot in which a plurality of votes is cast by a voting input device, the apparatus comprising: means for receiving voting preference data for the or each vote; wireless communication means for receiving a voting input from the voting input device, the voting input confirming that the voting preference data is to be used; and means for recording votes in the ballot, adapted to record the or each vote in accordance with the voting preference data, in response to receiving the voting input. The apparatus may be a computer, for example, adapted for use with an electronic voting system, and the voting input device may be an electronic voting handset or a computer in wireless communication with the apparatus. The wireless communication means may include a wireless transceiver or receiver (such as a radio frequency transceiver or receiver, infrared communication device, or any other means allowing the apparatus to communicate with a device that is not physically connected to the apparatus). The wireless communication means may alternatively comprise a suitable interface and/or controlling means for communicating with such a wireless transceiver or receiver in order to communicate with a wireless device.

By receiving voting preference data and then recording votes in accordance with the voting preference data when a voting input is received to confirm that the data should be used, the user input required from the voter during a particular ballot can be reduced and, accordingly, the voting user interface is simplified. The integration of potentially complicated split votes within an electronic voting system can also allow definitive voting results to be presented relatively quickly, for example within seconds of the conclusion of the ballot.

The means for receiving voting preference data is preferably adapted to receive data representing the distribution of the or each vote between different voting choices in the ballot. The voting preference data may, for example, represent absolute numbers of votes to cast for each respective voting choice (such as ‘FOR’, ‘AGAINST’, ‘ABSTAIN’), or may represent percentages or proportions of votes to allocate to each voting choice. The vote preference data may be received from a vote registration computer or the like. The vote preference data and/or the voting input may be received from a location different to the location in which the ballot is to be conducted, for example to allow remote voting. Votes may be indivisible, especially in the case where the or each vote consists of a plurality of votes, in which case only whole numbers of the or each votes may be assigned to different voting choices. Alternatively, especially when only one vote is to be cast, fractions of the or each vote may be allocated to different voting choices.

The apparatus may further comprise means (such as a hard disc or other physical device, or a database or other logical device) for storing the voting preference data. This dedicated storage means can allow ‘pending’ votes to be kept separate from ‘recorded’ (cast) votes, and can thus improve voting security and confidentiality. The ‘pending’ votes may be made unavailable to the parties operating the ‘recorded’ vote database, for example, to reduce the risk of fraud.

The apparatus may further comprise means for validating the voting preference data. Thus, a check can be made to ensure that the total number of split votes totals exactly the same number as or (if preferred) no more than the number of votes allocated to the voting input device/voter. This provides the additional benefit that, since the voting preference data has already been validated, the voting input which is transmitted during the voting period need not be validated, which can allow the vote to be conducted more efficiently. The apparatus may additionally or alternatively comprise means for authenticating the voting preference data, for example by cross-referencing against a list of registered voters. This can further improve the security of the voting operation, and reduce or eliminate the need for voter authentication during the voting period.

The apparatus may further comprise means for outputting the voting preference data, preferably in the form of a printer for generating printed receipts. This can provide a clear, accurate and verifiable log of votes which have been cast.

The apparatus may further comprise means for generating a unique identifier associated with the voting preference data, the means for outputting voting preference data being adapted also to output the voting preference unique identifier (using a printer, for example, and optionally printing the identifier in combination with the relevant voting preference data to facilitate the association of one with the other). This identifier is unique both to a given ballot and to a particular voter/voting input device, and can allow a particular instance of voting preference data to be clearly and unambiguously referenced within the context of an AGM, for example, which may have a plurality of voters and a plurality of ballots. The identifier may, however, be unique only within the context of a single ballot, a single voter, or a single event (such as an AGM), the identifiers being reused otherwise. The identifier may, for example, be an internal database reference relating to relevant voting preference data stored in the database

The apparatus may further comprise means for transmitting the voting preference unique identifier to the voting input device for display when voter confirmation is requested in relation to the voting preference data associated with the identifier. By having the voting preference unique identifier displayed, this can allow the operator of the voting input device to confirm (with reference, for example, to a printed voting preference data receipt showing the voting preference identifier as mentioned above) that the correct votes will be cast. This can be done without the need to display the actual votes which are to be cast at the voting input device (thus simplifying the information presented to the voter during the voting period and preventing the need to transmit and display the voting preference data during the vote, which can reduce the potential for voting fraud).

The means for receiving a voting input may be adapted to receive an input negating the confirmation that the voting preference data is to be used, the means for recording votes being further adapted not to record the or each vote if such an input is received more recently than a voting input confirming that the voting preference data is to be used. Thus a voter can retract the casting of a vote in accordance with the voting preference data during the voting period, for example if new information comes to light during that period. The voter may recast and reretract the vote subsequently, providing greater control over the voting process than with former paper-based systems (where a vote cannot easily be uncast). In the absence of any voting input (either confirming or negating the confirmation that a vote is to be cast), the vote will normally be assumed not to have been cast, although an opposite assumption may be made.

The means for receiving voting preference data may be adapted to receive voting preference data for a plurality of ballots, the means for recording votes being adapted to process the voting preference data to select voting preference data relating to the current ballot, and to record votes for the ballot in accordance with the selected voting preference data. This can allow a voter to participate in a plurality of ballots with one registration session, for example. The processing of the voting preference data on a per ballot basis allows voting rules to be respected, for example, regarding requiring the voter to be present at each vote, and to cast each vote (in this case, confirmation of a vote) in person.

The apparatus may further comprise means (such as a keyboard and/or a pointing device, for example a mouse) for inputting voting preference data. The means for inputting voting preference data may be adapted to input voting preference data for a plurality of ballots (such as a series of motions put forward at an AGM). The input means may be provided by a registration computer in a secure and private location, or may be provided by the same computer which conducts the ballots, for example. A further registration computer or computers may be provided to carry out the registration of all voters, many of whom may not require or desire the option of casting split votes, and the programming of voter smartcards. This can allow the computers that provide voting preference input means to be used only by (or on behalf of) voters who are casting split votes (these voters tending also to require a high level of service, which such separate registration systems can provide). The input means may alternatively be provided in a voting handset (such as the voting input device), or a portable computer, or other device, and it may present to the user a ‘virtual ballot paper’, providing similar fields to a paper poll card. Means may be provided, for example, to facilitate data entry, for example by calculating the number of votes remaining after some votes have been allocated to one or more voting choices, and optionally proceeding to allocate the calculated remaining votes to remaining voting choice(s).

The apparatus may further comprise means for copying voting preference data associated with a first ballot to create voting preference data associated with a second ballot. This could be, for example, by allowing an operator to select the first ballot, and to click a copy button associated with the second ballot. The copying may involve copying the voting preference data relating to the first ballot, for example, and/or it may involve creating a reference to the first ballot, for incorporation in the voting preference data relating to the second ballot. This can allow votes to be cast for a series of ballots more quickly.

The means for receiving voting preference data may be adapted to receive amended voting preference data to replace previous voting preference data. Thus, a voter associated with the voting input device may alter the voting preference data, for example as a result of hearing a debate about a motion to be voted on. In the case where a receipt has been printed in respect of the voting preference data, the receipt may be reprinted to ensure that the voting receipt remains an accurate record of the votes which are to be cast. The means for recording votes may further be adapted to record the or each vote in response to the reception of amended voting preference data, for example as a result of the voting preference data being amended during the course of the vote, rather than in response to receiving confirmation from the voting input device for example. In this case, the voting procedure is simplified, and the vote may be cast without the aid of the voting input device.

The apparatus may further comprise means for outputting a voter identifier, associated with the voter casting the or each vote, for use with the voting input device. This can allow voting input devices and voting preference data to be linked to the voter who is casting the relevant plurality of votes. The means for outputting a voter identifier may also be adapted to output the voter identifier to a portable data storage device (such as a smartcard) for use with the voting input device. This can provide a flexible and replaceable identification and authentication system.

If the apparatus comprises means for receiving an indication that a voting period associated with the ballot has commenced and the means for recording votes is adapted to record votes for the ballot in response to receiving the indication, then the means for recording votes may be configurable to record votes for which voting preference data has already been received in response to receiving the indication that the ballot has commenced. This provides an ‘autovote’ feature which (if the rules governing the voting permit) allows votes to be cast during the appropriate voting period without the input (or presence) of the voter.

The apparatus may further comprise means for computing a ballot result in dependence on the recorded votes. The result may be output/displayed, as appropriate. This can facilitate the rapid display of a ballot result once one or more ballots have been conducted.

The means for receiving voting preference data may be adapted to receive the voting input from a location different to the location in which the ballot is conducted. The use of the voting preference data requires less information to be transmitted in the voting input, and thus it is more difficult to manipulate the voting result as a whole by manipulating of the voting input, especially when the reception of voting preference data has previously been authenticated. In view of the reduced security which is required with respect to the voting input, the casting of a vote may be carried out from a remote location, by telephone, text message, e-mail or via a web interface, for example. Nevertheless the receipt of voting input may also be authenticated and/or encrypted. The voting preference data may also be received from a remote location. By providing such features, voting may be carried out without any physical presence in a designated voting location.

In another aspect of the invention there is provided a voting input device (such as a voting handset or a laptop or other computer) for casting at least one vote in a ballot, comprising: means for displaying an indication (such as an LCD screen and associated control hardware and software) that voting preference data has been provided for the or each vote; means (such as a keypad or other input means) for receiving user confirmation that the or each vote is to be recorded in accordance with the voting preference data; and wireless communication means (such as a wireless transceiver) for transmitting a voting input to indicate that the user has provided the confirmation that the or each vote is to be recorded.

The voting input device may further comprise means for displaying a unique identifier associated with the voting preference data, and may further comprise means for receiving an input (such as a ‘cancel’ key) negating the confirmation that the voting preference data is to be used, the means for transmitting a voting input being adapted to transmit a voting input to indicate that the confirmation relating to the voting preference data has been negated (as noted above, an assumption may be made as to the voting intention of the voter if no voting input is received). The voting input device may further comprise means for displaying data representative of user input relating to the ballot (such as the currently selected voting choice, which may be an indication simply that the vote has been cast). The means for receiving user confirmation may be adapted to respond to a single input, such as a single key press. Thus a complicated split vote may be cast in a ballot using a minimum of interaction from the voter.

If the voting input device further comprises means for inputting voting preference data and means for transmitting the voting preference data, the means for inputting voting preference data may be adapted to input voting preference data for a plurality of ballots. Thus all aspects of the voting system may be provided using only the apparatus and voting input device as aforesaid, without requiring a separate voting registration computer, for example.

The voting input device may further comprise means for receiving a voter identifier, in which case the means for receiving a voter identifier may be adapted to receive the voter identifier from a portable data storage device attachable to the voting input device (such as a smartcard, for example). The voting input device may further comprise means for receiving an indication that a voting period associated with the ballot has commenced, the means for transmitting a voting input being then adapted to transmit the voting input in response to receiving the indication that the voting period has commenced. The voting input device may also comprise means for displaying the voting preference data (such as a display of the actual numbers, proportions or percentages of votes which are to be cast for each voting choice).

The voting input device may also comprise means for displaying a list of voting choices, means for receiving a user selection of one of the displayed voting choices, and means for transmitting a voting input corresponding to the selected voting choice. Accordingly, the voting input device can also be used to cast ‘live’ votes during the ballot.

In another aspect of the invention there is provided a method of conducting a ballot in which a plurality of votes is cast by a voting input device, the ballot having an opening time, and the method comprising the steps of: before the ballot opening time, receiving voting preference data for the or each vote; after the ballot opening time, receiving a voting input from the voting input device, the voting input confirming that the voting preference data is to be used; and recording votes in the ballot, comprising recording the or each vote in accordance with the voting preference data in response to receiving the voting input.

In a further aspect of the invention there is provided a method of casting at least one vote in a ballot, comprising: displaying an indication that a voting preference data has been provided for the or each vote; receiving user confirmation that the or each vote is to be recorded in accordance with the voting preference data; and wirelessly transmitting a voting input to indicate that the user has provided the confirmation that the or each vote is to be recorded.

In another aspect of the invention there is provided a voting system for conducting a ballot in which a plurality of votes is cast by a voter, the system comprising apparatus for conducting a ballot as aforesaid; and at least one voting handset as aforesaid. A vote registration computer or the like may also be provided.

In a yet further aspect of the invention, there is provided a method of conducting a ballot in which at least one vote is cast by a voter, the method comprising: receiving a voting preference for the or each vote; initiating the ballot after receiving the voting preference; receiving a confirmation from the voter to use the registered voting preference; and recording the or each vote in accordance with the voting preference.

In another aspect of the invention there is provided a method of casting at least one vote in a ballot, the method comprising: registering a voting preference for the or each vote; receiving an indication that a voting period associated with the ballot has commenced; and confirming that the or each vote is to be cast in accordance with the registered voting preference.

In a further aspect of the invention there is provided a voting receipt, comprising data identifying a ballot in which at least one vote is to be recorded, voting preference data indicating how the or each vote is to be allocated between different voting choices in the ballot, and a unique identifier associated with the voting preference data.

In a yet further aspect of the invention there may be provided at least one signal tangibly embodying data (or sets of data) generated in accordance with any method as aforesaid.

The present invention can be implemented in any convenient form, for example using dedicated hardware, or a mixture of dedicated hardware and software. The present invention is particularly suited to implementation as computer software implemented by a workstation or laptop computer. The aforementioned network can comprise any local area network or even wide area, conventional terrestrial or wireless communications network (for example if a vote is to be conducted across a plurality of geographically disparate sites). The apparatuses can comprise any suitably programmable apparatuses such as a general purpose computer, personal digital assistant, mobile telephone (such as a WAP or 3G-compliant phone) and so on. Aspects of the present invention encompass computer software implementable on a programmable device. The computer software can be provided to the programmable device using any conventional carrier medium. The carrier medium can comprise a transient carrier medium such as an electrical, optical, microwave, acoustic or radio frequency signal carrying the computer code. An example of such a transient medium is a TCP/IP signal carrying computer code over an IP network, such as the Internet. The carrier medium can also comprise a storage medium for storing processor readable code such as a floppy disk, hard disk, CD ROM, magnetic tape device or solid state memory device.

Although each aspect and various features of the present invention have been defined hereinabove independently, it will be appreciated that, where appropriate, each aspect can be used in any combination with any other aspect(s) or features of the invention.

Embodiments of the present invention will now be described with reference to the accompanying drawings, in which:

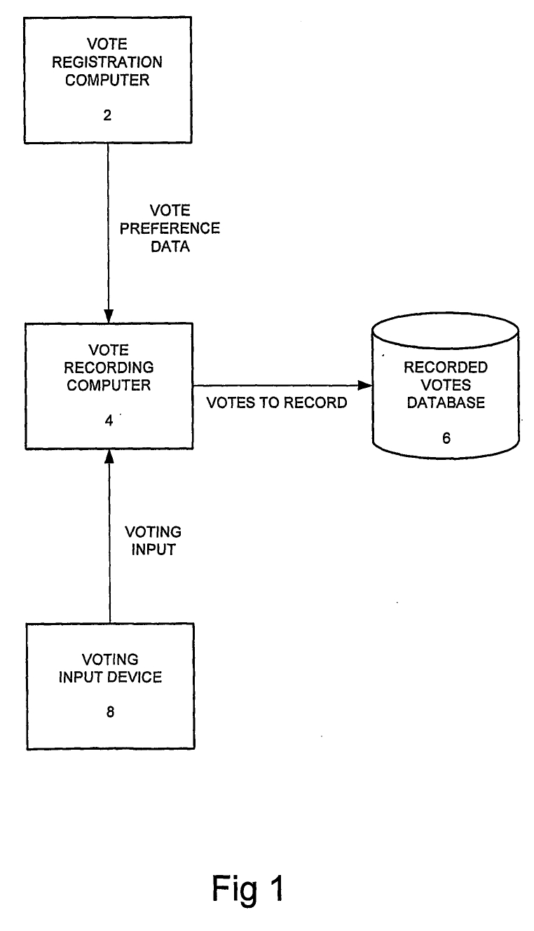

FIG. 1 is a schematic diagram of a voting system in accordance with an embodiment of the present invention;

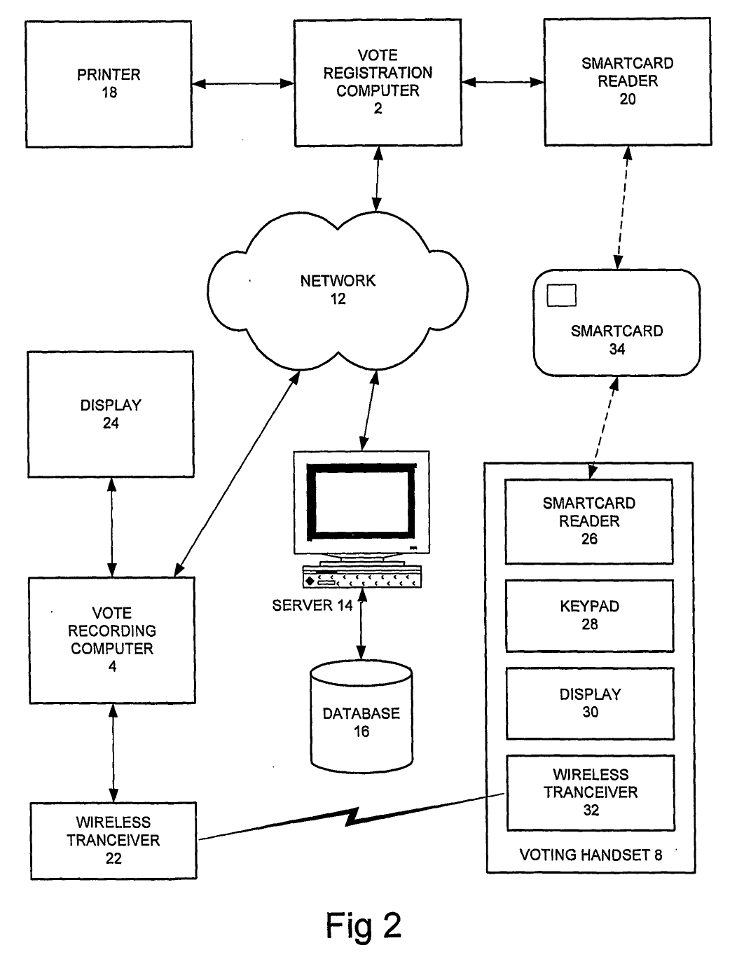

FIG. 2 is a schematic diagram of the voting system of FIG. 1 in more detail;

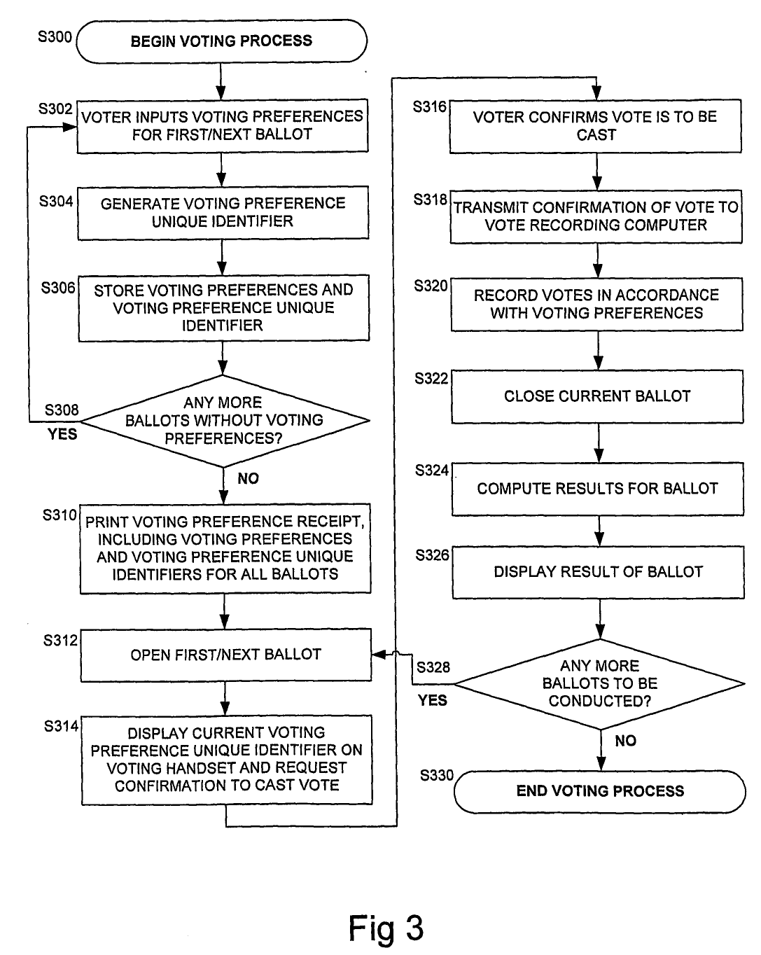

FIG. 3 is a flowchart detailing the steps for conducting a series of ballots using the voting system;

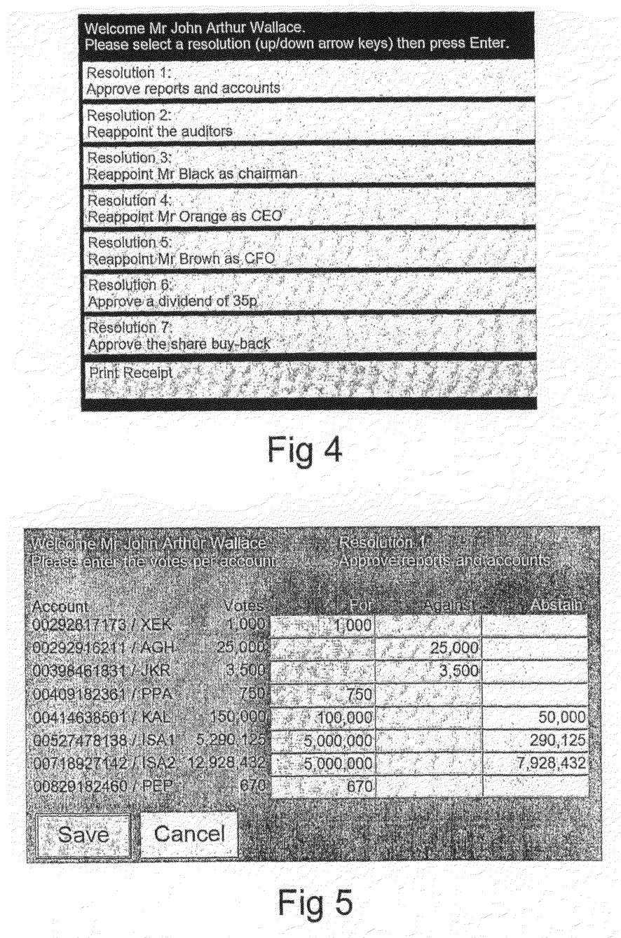

FIG. 4 is a screenshot illustrating the vote preference registration process of the voting system;

FIG. 5 is a further screenshot illustrating the vote preference registration process of the voting system;

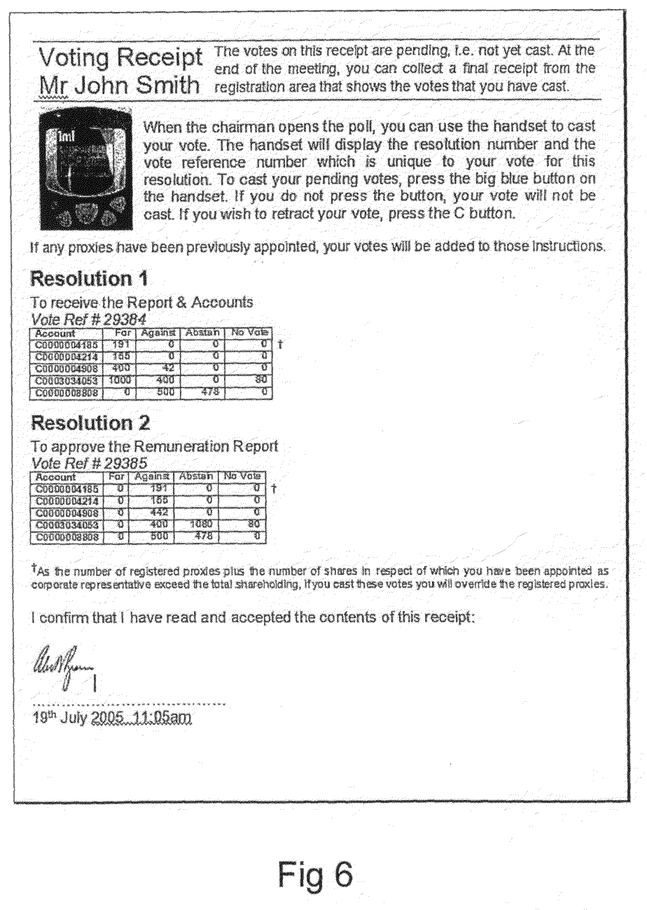

FIG. 6 is an illustration of a voting receipt generated by the voting system; and

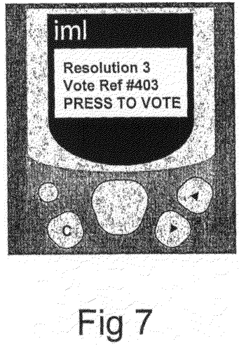

FIG. 7 is an illustration of the voting handset display during the progress of a ballot conducted by the voting system.

A voting system in accordance with a first embodiment of the present invention will now be described in overview, with reference to FIG. 1.

In FIG. 1 a vote registration computer 2, vote recording computer 4, recorded votes database 6 and voting input device 8 are shown. Although shown separately in this figure, some or all of these elements may be provided as integrated units (such as a single workstation or laptop, for example).

The system is used, for example, by a voter who is entitled to cast at least one vote. Before the ballot is opened, the user interacts with the vote registration computer 2 to record his voting preferences for all (or part of) his allocated votes. For example, the voter may have 300 votes, and he may decide to allocate 200 votes to vote for a motion, to allocate 50 votes to vote against a motion, and to abstain with the remaining 50 votes. The voter, or a trained operator, would then enter these values in the vote registration computer 2.

The vote recording computer 4 then receives the vote preference data from the vote registration computer (although, as noted above, these may be one and the same device). When the ballot is opened (that is, the voting period commences), the voter is notified of this fact, and his is asked to confirm whether or not he wishes to cast the votes for which the preferences have been recorded. His response (the voting input) is transmitted to the vote recording computer 4 for processing. If the voting input confirms that the votes are to be cast, the voting recording computer 4 then records the relevant votes (in this case, 200 FOR, 50 AGAINST, 50 ABSTAIN) in the recorded votes database 6 which is used to hold all of the votes cast in the ballot by all voters.

Thus it will be appreciated that a complex split vote can be cast during the voting period by only a single operation. This can allow the vote to be carried out quickly and reliably.

The voting system can be used for a series of consecutive ballots, for example corresponding to a series of motions at a company Annual General Meeting (AGM), as explained in more detail below.

FIG. 2 shows the voting system in more detail.

In the system at least one vote registration computer 2, a vote recording computer 4 and a server 14 are connected via a local area network 12. A voting handset 8 is also provided, in wireless communication with the vote recording computer 4. The vote registration computer 2 is connected to a printer 18 and a smartcard reader 20, for use with a smartcard 34. The vote recording computer 4 is attached to a display 24 for displaying voting instructions and ballot results and also to a wireless transceiver 22 (which may be part of a voting handset acting in a ‘base station’ mode) for communication with voting handsets. The server 14 includes a database 16, provided on at least one hard disk or similar storage device attached to the server. The voting handset 8 includes a smartcard reader 26 for communication with the smartcard 34, a keypad 28 for entering voting inputs, a display 30, and a wireless transceiver 32.

The vote registration computer 2 is a workstation or laptop computer, providing a suitable user interface for the input of vote preference data. The data entry systems will be described in more detail below with reference to FIGS. 4 and 5. The registration computer 2 is also used to register voters on the system. Application software running on the computer 2 uses a smartcard reader 20 to program a smartcard 34 with a reference unique to the voter. When the voter later inserts the smartcard into a voting handset, the handset uses the voter identifier to retrieve and to submit voting information specific to the voter in question. When the voting preference data has been entered, a voting receipt is printed by the printer 18 attached to the registration computer 2, providing a permanent and verifiable record of the vote which is to be cast. Each page of the voting receipt is then signed by the authorised voter, and a copy of the signed receipt is retained by the ballot administrator. The voting receipt will be described in more detail below with reference to FIG. 6. The vote registration computer 2 communicates with the server 14 over the network 12 to store the voting preference and other data.

The vote recording computer 4 is a workstation, laptop computer or other suitable device executing software to control the collection, storage and computation of votes (although separate subsystems may be provided as required). The computer 4 is in communication with a plurality of handsets (including handset 8) via a wireless transceiver 22, as mentioned above. A display 24, such as a monitor or projector, is provided to display voting instructions (including a description of the subject matter of the current ballot, an instruction to use the voting handsets to cast a vote, and optionally an indication of the remaining time for casting a vote) and to assist operation of the computer 4.

In use, the vote recording computer 4 receives an appropriate input (a key press, electronic message or otherwise) from the supervisor of the ballot to signal that a ballot is to be opened. The computer 4 then accesses the server 14 to retrieve the voting preference data for all relevant voters from the database 16 (more particularly, a database of ‘pending’, that is not yet cast, votes), and displays the appropriate voting instructions to all of the voters on the display 24. The computer 4 also transmits the necessary instructions (including, where appropriate, a list of available voting choices) to the voting handsets via the transceiver 22 to cause the voting handsets to request inputs from the respective voters. Voting inputs, corresponding to selected voting choices, or a confirmation that voting preference data is to be used, are then received from the handsets, and processed accordingly. When the ballot closes, the vote recording computer 4 communicates with the server 14 to record the cast votes in the database 16 (more particularly, a database of ‘recorded’, that is cast, votes). When all the ballots have been conducted, the vote recording computer then counts the votes and displays the ballot results on the display 24.

The voting handset 8 is a suitably modified handset from the system disclosed in EP 1 535 487. The handset 8 is enabled by the insertion of a suitably programmed smartcard 34, and communicates with the vote recording computer 4 via the wireless transceiver 22 to retrieve various types of information. By reading the voter identifier from the smartcard 34, the handset obtains and displays the name of the voter (which name may be obtained either from the database 16 via the vote recording computer 4, or from the smartcard 34). The vote recording computer 4 and/or server 14 also maintain various types of state information about a voter, including votes currently cast in an open ballot, for example. Thus, when a voter inserts his smartcard in the voting handset 8, the handset will interrogate the database 16 or vote recording computer 4 and display a current vote (for example a vote “FOR” a motion) which might have been entered at a different voting handset during the same ballot (using the same smartcard). Alternatively, a voting handset may be registered to a particular voter for the duration of a given ballot or sets of ballots without using an intermediary device such as a smartcard (for example by programming the handset directly, or by communicating with a registration computer or other input device).

When a ballot is opened, the voting handset determines (by interrogating the smartcard 34, or by communication with the vote recording computer 4) whether or not voting preference data has been supplied for the current ballot. If such data has been supplied, the voting preference unique identifier is displayed (to allow the voter to cross-reference with the printed voting receipt showing the actual votes which are intended to be cast) and the voter is presented with only one option: to cast the vote (by a single press of a nominated voting button). Once the vote has been cast, a voting input is transmitted to the vote recording computer 4 to confirm that the voting preference data is to be used, and the handset display indicates that the vote has been cast. The voter is then given another single choice: to cancel the vote (by a single press of a nominated cancel button); if this has been done, the handset once again offers the voter the option of casting the vote again (and so on).

If, on the other hand, no voting preference data has been supplied, the voter is given a list of voting choices which are to be applied to all of the or each vote which the voter has been allocated. Thus, for example, the user may be given the option of pressing ‘1’ to cast all votes ‘FOR’ a motion, to press ‘2’ to cast all votes ‘AGAINST’ a motion, and to press ‘3’ to ‘ABSTAIN’ with all votes. Once a choice has been made, the appropriate voting input is transmitted to the vote recording computer 4 and the handset display indicates which vote has been cast. The vote may be changed at any time while the ballot is open by pressing a button corresponding to a different voting option; the appropriate amended voting input is then transmitted and the display updated as appropriate.

If the voter decides to cast a portion of his vote in advance, and to cast the remaining portion of his vote ‘live’, he may be provided with two smartcards for use during the voting period. In this case, one smartcard is registered with voting preference data as described above, and the other smartcard is registered without any voting preference data. Thus, inserting one smartcard during the ballot will provide the ‘cast or not’ choice (in respect of the voting preference data), and the other smartcard will allow the voter to choose ‘live’ how to proceed with the remaining votes by selecting from the available options. Other possibilities for achieving this result are of course possible, but this method allows complex votes to be cast whilst retaining a simple user interface. When a smartcard is registered, a flag is set in the smartcard memory to indicate (both to the voting handset, and to the registration computer) that it is to be used to cast a split vote. If the relevant flag is not set, the voting handset will permit a ‘live’ vote. The voting handset and registration computer may alternatively communicate with the server or other device to determine the split voting status. There may also be provided one flag per ballot (allowing the split voting to be used for some but not for others), or one flag in respect of all ballots.

The steps used to operate the voting system will now be described in more detail with reference to FIG. 3.

When the voting process begins (step S300), the voter inputs his voting preferences for the first (and possibly only) ballot (step S302). An identifier is then generated in relation to the set of voting preferences which is unique both to that voter and to that ballot (that is, the identifier is used only once in relation to all voting preference data input for all ballots and all voters in a given voting session) in step S304. The voting preference data and voting preference unique identifier are then stored (step S306), in a ‘pending’ vote database. The process (steps S302-S306) is then repeated (step S308) for all remaining ballots. If a simpler vote is required (that is, a vote where all of the voters votes are to be cast ‘live’ during the ballot and only in respect of one of the possible voting options) steps S302-S308 are omitted, and steps S314-S320 are replaced by an appropriate alternative voting process which does not use voting preference data. When the registration process is complete, a voting receipt is printed (step S310) and (optionally) the receipt is signed by the voter and a copy of the signed receipt is retained for evidentiary purposes. The receipt includes details of the voting allocations for all ballots, and gives the voting preference unique identifier for each of the ballots.

When the first ballot is opened (S312), data is transmitted to the voting handsets to cause them to display the current voting preference unique identifier and to request the voter's confirmation that the vote should be cast (step S314). The voter can then check his voting receipt to check (using the voting preference unique identifier to cross-reference) that the correct votes will be cast, and if he is satisfied, he can confirm that the vote is to be cast (step S316) by pressing the appropriate button or other input on the voting handset. The handset transmits the vote confirmation to the vote recording computer (step S318), and the vote recording computer then records the relevant votes in accordance with the voter's prespecified voting preferences (step S320). In due course, the current ballot is then closed (step S322) and no further voting is possible. A result is then computed (step S324) for the ballot, and the result is made available (step S326). The voting process (steps S312-S326) is then repeated for all remaining ballots (step S328). The voting process is then complete (step S330). The results of each ballot may alternatively be computed and/or displayed only after all of the ballots have been closed.

The input means provided at the vote registration computer will now be described in more detail, with reference to FIGS. 4 and 5.

FIG. 4 is a partial screenshot of the menu screen which is displayed when a smartcard, preprogrammed with the identity of a voter, is inserted in the smartcard reader connected to the vote registration computer (the smartcard may alternatively be programmed by the vote registration computer itself prior to displaying the menu in question). The set of ballots (“Resolution 1”, “Resolution 2”, and so on) in which the voter is participating is displayed as a series of menu items, giving details of the subject matter of each ballot (such as “To approve the Remuneration Report”). Information may also be displayed to indicate whether voting preference data has been provided for each ballot, and options may be provided, for example, to copy the voting preference data associated with one ballot to create voting preference data associated with another ballot. Each resolution can be selected (by clicking on the text bar, for example) to display or to input further information regarding the ballot (see below).

FIG. 5 is a partial screenshot of the ballot information screen, in which voting preference and other data can be entered and/or viewed. The screen displays details of all of the votes which are allocated to the voter, including the total number of votes. There may be more than one set of votes available to be cast; in FIG. 5, for example, the voter is authorised to vote as proxy for a plurality of shareholder accounts, each having a certain number of votes associated with it. The voter (or computer operator acting on behalf of the voter) can then specify how the votes are to be allocated across the voting choices (such as ‘for’, ‘against’ and ‘abstain’) for the ballot in question. A facility is provided whereby, if a certain number of votes is allocated to one voting choice, the remainder of the votes can be automatically allocated to another voting choice using a designated keypress or other input. The numbers of votes allocated are also validated to ensure that they do not exceed the total number of votes which are available. A further check can be made to warn the voter if not all votes have been cast. When all information has been provided, the information is saved. The system also allows the vote preference data to be amended and resaved, in which case an amended voting receipt will be printed. If the data is amended during the course of a vote, the data will be directly recorded as a vote, rather than saved. Furthermore, if a voter smartcard is inserted in the smartcard reader of the vote registration computer during the course of a vote, the computer will jump straight to the vote preference data input screen for the current ballot (bypassing the menu showing all ballots). These features help to provide a more efficient registration and voting system.

FIG. 6 shows a sample voting receipt printed by the vote registration computer. The receipt includes instructions on casting the votes, and a list of the voting preference data for all of the ballots, including a voting preference unique identifier (“Vote Ref #”) for each set of voting preference data. For each ballot, the number of votes cast for each account (subdivisions of the allocated votes) are shown separately. Totals and/or aggregated voting information can be provided instead if desired.

The receipt includes an indication of date and time. Thus, if the voting preference data is amended and a new receipt is printed, it is possible to determine which receipt is the most up-to-date (that is, the valid receipt). The voting preference unique identifiers are generated by combining a voter identifier with a ballot identifier, which can create relatively short and human-readable unique identifiers. Other ways of generating unique identifiers may be used, however, including generating random identifiers with a sufficiently large number range to avoid accidental repetition of IDs, or using a global ID index which is incremented every time a new ID is issued. Also, new voting preference unique identifiers may be generated every time a new receipt is printed, in order to avoid the voter cross-referencing the unique identifiers with an old (invalid) voting receipt.

FIG. 7 is a diagram illustrating the voting handset display during the course of a ballot, in the case that voting preference data has been presubmitted. Details of the current ballot and the current voting preference unique identifier are displayed, and the voter confirmation of the vote is requested. Pressing the central (unmarked) button causes the vote to be cast. The “C” button causes a cast vote to be cancelled.

In a further embodiment, the voting system described above is applied more broadly, for example within a partly or fully paper-based voting system. Accordingly, voting preference data can be recorded on poll cards, and validated poll cards can be stored as ‘pending’ votes, which may be retracted before they are cast. The validation of the poll cards at the registration stage increases the speed of subsequent votes.

In a variant of this embodiment, a separate (optionally pre-validated) poll card is generated in a standard format for each ballot. Each poll card is then put in a ballot box for each respective ballot. Thus the voting preference data can be altered or retracted for later ballots even after the first ballots have been completed. Furthermore, a voting rule that the voter must be present for each relevant vote can more easily be enforced. The use of pre-formatted and/or pre-validated poll cards also allows the voting result to be more quickly computed.

Whilst the voting system mentioned above has been described with reference, amongst other things, to Annual General Meetings (AGMs), it will be appreciated that the system can be applied to any voting system, and especially to voting systems allowing more than one vote per voter. The system may also be used, for example, to conduct ballots using a single transferable vote or similar voting system (where the voting preference data may comprise a list of voting choices in an order of priority, or a list of voting choices and associated values implying a voting priority, for example).

The system can further be used to conduct an election, where only a single non-transferable vote is cast by each voter for one option from a list of options, for example. Registration can take place for the election in advance of the polling period/day, at which point authentication of each voter's identity and verification of each voter's right to vote can be undertaken, at the same time as recording the voter's voting preference. This can be done anonymously, for example using voting preference unique identifiers. The act of casting a vote can then be done by any means described above during the polling period/day to transmit confirmation of the vote (by sending a confirmation message including the unique vote preference ID, for example), using means (such as a text message, phone call, e-mail, web form, and the like) which may be less secure than the means which are normally used, due to the necessary authentication and registration procedures already having been completed. The voting preference may, if desired, be changed during the polling period/day by any suitable means mentioned above, but less work would need to be done during the polling period/day since many people will remain committed to their initial voting preference.

Other applications of the system and method are of course possible including, as described above, both electronic and/or non-electronic (such as paper-based) voting systems. It will also be appreciated that the above system may be put into effect using remote devices other than the voting handsets described above, and such remote devices may communicate with the vote registration computer and/or vote recording computer other than wirelessly, for example using a computer network. The term ‘remote device’ may encompass devices other than input devices (such as a keyboard, a mouse, touch screen, and so on) connected directly to the vote recording or registration computer.

Further modifications lying within the spirit and scope of the present invention will be apparent to a skilled person in the art.

1. Apparatus for conducting a ballot in which at least one vote is cast by a voting input device, the apparatus comprising:
means for receiving voting preference data for the or each vote;
wireless communication means for receiving a voting input from the voting input device, the voting input confirming that the voting preference data is to be used; and
means for recording votes in the ballot, adapted to record the or each vote in accordance with the voting preference data in response to receiving the voting input.

2. Apparatus according to claim 1, wherein the means for receiving voting preference data is adapted to receive data representing the distribution of the or each vote between different voting choices in the ballot.

3. Apparatus according to claim 1, further comprising means for storing the voting preference data.

4. Apparatus according to claim 1, further comprising means for validating the voting preference data.

5. Apparatus according to claim 1, further comprising means for authenticating the voting preference data.

6. Apparatus according to claim 1, further comprising means for outputting the voting preference data.

7. Apparatus according to claim 6, further comprising means for generating a unique identifier associated with the voting preference data, and wherein the means for outputting voting preference data is adapted also to output the voting preference unique identifier.

8. Apparatus according to claim 7, further comprising means for transmitting the voting preference unique identifier to the voting input device for display when voter confirmation is requested in relation to the voting preference data associated with the identifier.

9. Apparatus according to claim 1, wherein the means for receiving a voting input is adapted to receive an input negating the confirmation that the voting preference data is to be used, and the means for recording votes is further adapted not to record the or each vote if such an input is received more recently than a voting input confirming that the voting preference data is to be used.

10. Apparatus according to claim 1, wherein the means for receiving voting preference data is adapted to receive voting preference data for a plurality of ballots, and wherein the means for recording votes is adapted to process the voting preference data to select voting preference data relating to the current ballot, and to record votes for the ballot in accordance with the selected voting preference data.

11. Apparatus according to claim 1, further comprising means for inputting voting preference data.

12. Apparatus according to claim 11, wherein the means for inputting voting preference data is adapted to input voting preference data for a plurality of ballots.

13. Apparatus according to claim 12, further comprising means for copying voting preference data associated with a first ballot to create voting preference data associated with a second ballot.

14. Apparatus according to claim 1, wherein the means for receiving voting preference data is adapted to receive amended voting preference data to replace previous voting preference data.

15. Apparatus according to claim 14, wherein the means for recording votes is adapted to record the or each vote in response to the reception of amended voting preference data.

16. Apparatus according to claim 1, further comprising means for outputting a voter identifier, associated with the voter casting the or each vote, for use with the voting input device.

17. Apparatus according to claim 16, wherein the means for outputting a voter identifier is adapted to output the voter identifier to a portable data storage device for use with the voting input device.

18. Apparatus according to claim 1, further comprising means for receiving an indication that a voting period associated with the ballot has commenced, and wherein the means for recording votes is adapted to record votes for the ballot in response to receiving the indication.

19. Apparatus according to claim 18, wherein the means for recording votes is configurable to record votes for which voting preference data has already been received in response to receiving the indication that the ballot has commenced.

20. Apparatus according to claim 1, further comprising means for computing a ballot result in dependence on the recorded votes.

21. Apparatus according to claim 1, wherein the means for recording votes is adapted to record at least one further vote in accordance with a further voting input, specifying a voting choice in the ballot, received from the voting input device.

22. Apparatus according to claim 1, wherein the means for receiving a voting input is adapted to receive the voting input from a location different to a location in which the ballot is conducted.

23. A voting input device for casting a plurality of votes in a ballot, comprising:
means for displaying an indication that voting preference data has been provided for the or each vote;
means for receiving user confirmation that the or each vote is to be recorded in accordance with the voting preference data; and
wireless communication means for transmitting a voting input to indicate that the user has provided the confirmation that the or each vote is to be recorded.

24. A voting input device according to claim 23, further comprising means for displaying a unique identifier associated with the voting preference data.

25. A voting input device according to claim 23, further comprising means for receiving an input negating the confirmation that the voting preference data is to be used, and wherein the means for transmitting a voting input is adapted to transmit a voting input to indicate that the confirmation relating to the voting preference data has been negated.

26. A voting input device according to claim 23, further comprising means for displaying data representative of user input relating to the ballot.

27. A voting input device according to claim 23, wherein the means for receiving user confirmation is adapted to respond to a single input.

28. A voting input device according to claim 23, further comprising means for inputting voting preference data, and means for transmitting the voting preference data.

29. A voting input device according to claim 28, wherein the means for inputting voting preference data is adapted to input voting preference data for a plurality of ballots.

30. A voting input device according to claim 23, further comprising means for receiving a voter identifier.

31. A voting input device according to claim 30, wherein the means for receiving a voter identifier is adapted to receive the voter identifier from a portable data storage device attachable to the voting input device.

32. A voting input device according to claim 23, further comprising means for receiving an indication that a voting period associated with the ballot has commenced, and wherein the means for transmitting a voting input is adapted to transmit the voting input in response to receiving the indication that the voting period has commenced.

33. A voting input device according to claim 23, further comprising means for displaying the voting preference data.

34. A voting input device according to claim 23, further comprising means for displaying a list of voting choices, means for receiving a user selection of one of the displayed voting choices, and means for transmitting a voting input corresponding to the selected voting choice.

35. A method of conducting a ballot in which at least one vote is cast by a voting input device, the ballot having an opening time, and the method comprising the steps of:
before the ballot opening time, receiving voting preference data for the or each vote;
after the ballot opening time, receiving a voting input from the voting input device, the voting input confirming that the voting preference data is to be used; and
recording votes in the ballot, comprising recording the or each vote in accordance with the voting preference data in response to receiving the voting input.

36. A method according to claim 35, wherein the step of receiving voting preference data further comprises receiving data representing the distribution of the or each vote between different voting choices in the ballot.

37. A method according to claim 35, further comprising storing the voting preference data.

38. A method according to claim 35, further comprising validating the voting preference data.

39. A method according to claim 35, further comprising authenticating the voting preference data.

40. A method according to claim 35, further comprising outputting the voting preference data.

41. A method according to claim 40, further comprising generating a unique identifier associated with the voting preference data, and wherein the step of outputting voting preference data further comprises outputting the voting preference unique identifier.

42. A method according to claim 41, further comprising transmitting the voting preference unique identifier to the voting input device for display when voter confirmation is requested in relation to the voting preference data associated with the identifier.

43. A method according to claim 35, wherein the step of receiving a voting input further comprises receiving an input negating the confirmation that the voting preference data is to be used, and the step of recording votes further comprises not recording the or each vote if such an input is received more recently than a voting input confirming that the voting preference data is to be used.

44. A method according to claim 35, wherein the step of receiving voting preference data further comprises receiving voting preference data for a plurality of ballots, and wherein the step of recording votes further comprises processing the voting preference data to select voting preference data relating to the current ballot, and recording votes for the ballot in accordance with the selected voting preference data.

45. A method according to claim 35, further comprising inputting voting preference data.

46. A method according to claim 45, wherein the step of inputting voting preference data further comprises inputting voting preference data for a plurality of ballots.

47. A method according to claim 46, further comprising copying voting preference data associated with a first ballot to create voting preference data associated with a second ballot.

48. A method according to claim 35, wherein the step of receiving voting preference data further comprises receiving amended voting preference data to replace previous voting preference data.

49. A method according to claim 48, wherein the step of recording votes further comprises recording the or each vote in response to the reception of amended voting preference data.

50. A method according to claim 35, further comprising outputting a voter identifier, associated with the voter casting the or each vote, for use with the voting input device.

51. A method according to claim 50, wherein the step of outputting a voter identifier further comprises outputting the voter identifier to a portable data storage device for use with the voting input device.

52. A method according to claim 35, further comprising receiving an indication that a voting period associated with the ballot has commenced, and wherein the step of recording votes further comprises recording votes for the ballot in response to receiving the indication.

53. A method according to claim 52, wherein the step of recording votes further comprises recording votes for which voting preference data has already been received in response to receiving the indication that the ballot has commenced.

54. A method according to claim 35, further comprising computing a ballot result in dependence on the recorded votes.

55. A method according to claim 35, wherein the step of recording votes further comprises recording at least one further vote in accordance with a further voting input, specifying a voting choice in the ballot, which is received from the voting input device

56. A method according to claim 35, wherein the step of receiving a voting input further comprises receiving the voting input from a location different to a location in which the ballot is conducted.

57. A method of casting at least one vote in a ballot, comprising:
displaying an indication that a voting preference data has been provided for the or each vote;
receiving user confirmation that the or each vote is to be recorded in accordance with the voting preference data; and
wirelessly transmitting a voting input to indicate that the user has provided the confirmation that the or each vote is to be recorded.

58. A method according to claim 57, further comprising displaying a unique identifier associated with the voting preference data.

59. A method according to claim 57, further comprising receiving an input negating the confirmation that the voting preference data is to be used, and wherein the step of transmitting a voting input further comprises transmitting a voting input to indicate that the confirmation relating to the voting preference data has been negated.

60. A method according to claim 57, further comprising displaying data representative of user input relating to the ballot.

61. A method according to claim 57, wherein the step of receiving user confirmation further comprises responding to a single input.

62. A method according to claim 57, further comprising inputting voting preference data, and transmitting the voting preference data.

63. A method according to claim 62, wherein the step of inputting voting preference data further comprises input voting preference data for a plurality of ballots.

64. A method according to claim 57, further comprising receiving a voter identifier.

65. A method according to claim 64, wherein the step of receiving a voter identifier further comprises receiving the voter identifier from a portable data storage device.

66. A method according to claim 57, further comprising receiving an indication that a voting period associated with the ballot has commenced, and wherein the step of transmitting a voting input further comprises transmitting the voting input in response to receiving the indication that the voting period has commenced.

67. A method according to claim 57, further comprising displaying the voting preference data.

68. A method according to claim 57, further comprising displaying a list of voting choices, receiving a user selection of one of the displayed voting choices, and transmitting a voting input corresponding to the selected voting choice.

69. A method of conducting a ballot in which at least one vote is cast by a voter, the method comprising:
receiving a voting preference for the or each vote;
initiating the ballot after receiving the voting preference;
receiving a confirmation from the voter to use the registered voting preference; and
recording the or each vote in accordance with the voting preference.

70. A method of casting at least one vote in a ballot, the method comprising:
registering a voting preference for the or each vote;
receiving an indication that a voting period associated with the ballot has commenced; and
confirming that the or each vote is to be cast in accordance with the registered voting preference.

71. A vote recording computer comprising:
a voting preference data receiving unit;
a wireless receiving unit for wirelessly receiving a voting input, the voting input confirming that the voting preference data is to be used; and
a vote recorder connected to the voting preference data receiving unit and the wireless receiving unit; wherein
the vote recorder is adapted to record at least one vote in accordance with voting preference data received by the voting preference data receiving unit in response to receiving the voting input.

72. A voting input device, comprising:
a display;
a user input device;
a wireless transmitter; and
a voting input control unit connected to the display, the user input device and the transmitter;
wherein the voting input control unit is adapted to display an indication that voting preference data has been provided for at least one vote, and to wirelessly transmit a voting input using the wireless transmitter to confirm that the or each vote is to be recorded in accordance with the voting preference data in response to receiving an appropriate user input via the user input device.

73. Apparatus for conducting a ballot in which at least one vote is cast by a voter and the ballot has an opening time, the apparatus comprising:
a data memory operable to store data to be processed;
an instruction memory storing processor implementable instructions;
a processor operable to read and process the data in accordance with instructions stored in the instruction memory;
a wireless receiver for wirelessly receiving a voting input from a voting input device;
wherein the instructions stored in the instruction memory comprise instructions for controlling the processor to perform a method comprising the steps of:
before the ballot opening time, receiving voting preference data for the or each vote;
after the ballot opening time, receiving a voting input from the voting input device, the voting input confirming that the voting preference data is to be used; and
recording votes in the ballot, comprising recording the or each vote in accordance with the voting preference data in response to receiving the voting input.

74. A voting input device for casting a plurality of votes in a ballot, the voting input device comprising:
a data memory operable to store data to be processed;
an instruction memory storing processor implementable instructions;
a processor operable to read and process the data in accordance with instructions stored in the instruction memory;
a display;
an input device; and
a wireless transmitter for wirelessly transmitting a voting input;
wherein the instructions stored in the instruction memory comprise instructions for controlling the processor to perform a method comprising:
displaying an indication that a voting preference data has been provided for the or each vote;
receiving user confirmation that the or each vote is to be recorded in accordance with the voting preference data; and
wirelessly transmitting a voting input to indicate that the user has provided the confirmation that the or each vote is to be recorded.

75. A voting system for conducting a ballot in which at least one vote is cast by a voter, the system comprising:
apparatus for conducting the ballot, comprising:
means for receiving voting preference data for the or each vote;
wireless communication means for receiving a voting input from the voting input device, the voting input confirming that the voting preference data is to be used; and
means for recording votes in the ballot, adapted to record the or each vote in accordance with the voting preference data in response to receiving the voting input; and
a voting input device for casting a plurality of votes in the ballot, comprising:
means for displaying an indication that voting preference data has been provided for the or each vote;
means for receiving user confirmation that the or each vote is to be recorded in accordance with the voting preference data; and
wireless communication means for transmitting a voting input to indicate that the user has provided the confirmation that the or each vote is to be recorded.

76. A voting receipt, comprising data identifying a ballot in which at least one vote is to be recorded, voting preference data indicating how the or each vote is to be allocated between different voting choices in the ballot, and a unique identifier associated with the voting preference data.

77. A voting receipt according to claim 76, further comprising an indication of at least one of a date and a time.

78. A carrier medium carrying computer readable code for controlling a computer to carry out a method of conducting a ballot in which at least one vote is cast by a voting input device, the ballot having an opening time, and the method comprising the steps of:
before the ballot opening time, receiving voting preference data for the or each vote;
after the ballot opening time, receiving a voting input from the voting input device, the voting input confirming that the voting preference data is to be used; and
recording votes in the ballot, comprising recording the or each vote in accordance with the voting preference data in response to receiving the voting input.
